(19) United States
(12) Patent Application Publication
(10) Pub. No.: US 2007/0143846 A1
(43) Pub. Date: Jun. 21, 2007

(54) System and method for detecting network-based attacks on electronic devices

(76) Inventor: HongQian Karen Lu, Austin, TX (US)

Correspondence Address: ANDERSON & JANSSON L.L.P., 9501 N. CAPITAL OF TX HWY #202, AUSTIN, TX, 78759, US

(21) Appl. No.: 11/314,626

(22) Filed: Dec. 21, 2005

(51) Int. Cl. G06F 12/14

(52) U.S. Cl. 726/23

(57) ABSTRACT

A system and method for detecting network-based attacks on an electronic device. The system and method operable to detect network-based attacks on the electronic device comprising receiving data packets on the electronic device, tracking disposition of the data packets by the electronic device by recording one or more paths through a finite state machine model of the processing of data packets by the electronic device, and raising an alert that the electronic device is under a network-based attack based on patterns of the one or more recorded paths.

### TECHNICAL FIELD

The present invention relates to the operation of network-based electronic devices, and more particularly, to systems and methods for detecting network-based attacks on such electronic devices.

### BACKGROUND OF THE INVENTION

One of the most vexing issues faced by the electronics industry, especially the electronic communications industry, is that the computer networks have become a favorite venue of various types of malfeasance.

One network security threat is the denial-of-service attach (DoS). The intent behind a denial-of-service attack is to prevent the legitimate user of a resource from accessing that resource, e.g., services available over the Internet. Large-scale DoS attacks have the potential to paralyze the Internet.

There are several types of DoS attacks. One example is flooding based attacks, such as SYN flooding and ICMP flooding. SYN flooding is a form of attack in which an attacker sends out a series of SYN requests without responding to the acknowledgement back from the target. A SYN request is a TCP packet used to initiate a new connection with a target computer. In the normal establishment of a TCP connection an initiating computer sends a SYN request to another computer (the responder). The responder then sends an acknowledgement back to the initiating computer (a SYN-ACK). The initiating computer, upon receipt of the synchronization acknowledgement, in the normal case, responds with an acknowledgement (ACK). This sequence is referred to as a three-way handshake. In a SYN flooding attack, the attacking computer repeatedly sends SYN requests to the target computer without completing the final ACK in the three-way handshake.

Similarly, ICMP flooding attacks is a form of attack in which the attacker sends many ICMP pings or UDP packets. The purpose is to send such a high quantity of data that the target must respond to, that the target is slowed down to the point of being disconnected from the service the target is accessing.

The most common type of DoS attack is the packet-flooding attack which may be aimed at preventing a server from providing services. In the packet-flooding attack an attacking computer sends a large number of packets to a destination computer, i.e., a targeted server, to cause excessive use of resources at the destination computer, thereby impairing the destination computer from performing tasks such as providing services, for example, the services against which the DoS attack is directed. [0010] One alternative DoS attack is referred to as a distributed denial-of-service (DDoS) attack, in which a large number of compromised hosts are organized to send packets to a victim-computer to consume excessively its resources or its Internet connection There are two kinds of DDoS attacks: direct attacks and reflector attacks. In a direct attack, an attacker arranges many compromised hosts to send a large number of packets directly toward a victim. In a reflector attack, the attacker uses intermediary nodes (routers and servers), called reflectors, to launch the attack. The attacker arranges many compromised hosts to send packets that require responses to reflectors such that the source addresses of the packets are set to the IP address of the victim. Without realizing the plot, reflectors send responses to the victim consuming the resources of the victim.

Common packet types used for DoS or DDoS flooding attacks include the following:
TCP packets—A flood of TCP packets with various flags set are sent to the victim. Common flags include SYN, ACK, and RST.
ICMP echo request/reply (also called Ping floods)—A flood of ICMP packets (echo request or echo reply) are sent to the victim.
UDP packets—A flood of UDP packets are sent to the victim.

The DoS or DDoS attacks can happen at the application layer as well as at network protocol layers. The DoS/DDoS defense mechanism must be constructed at both application and network protocol layers. Herein, unless explicitly stated to the contrary, DoS is intended to refer to both DoS and DDoS attacks.

One basic approach is to detect DoS attacks and to filter out attack packets. The Internet infrastructure is hierarchical. The attack detection and attack packets filtering can be done at different levels of the network, for example, at local computers, local networks, local ISP networks, or upstream ISP networks. The effectiveness of the attack detection and packet filtering is dependent on the network level or levels at which the defensive mechanisms are executed.

One prior art method of avoiding the impact of network-based attacks on resource-limited network devices is based on port hopping. With port hopping, the UDP/TCP port number used by the server varies as a function of time and uses a shared secret between the server and the client. While this method may be effective when the server and client can share a secret, it fails when that is not possible, e.g., as is the case with standard web services.

Most prior art detection methods are based on statistics of the packets that indicate a probability of network-based attack based on certain characteristics, for example, probabilities or distributions of certain types of packets, open port numbers, service requests, errors, or signatures (or patterns) of the packets flow (i.e., particular patterns of packets or sequences of packets). These methods require the understanding of normal or abnormal packets probabilities or signatures and being able to separate normal and abnormal packet flows. These systems need to be trained and be adaptable to changes of the statistics or signatures. Implementation-wise, most existing methods for host computers run in a separate processor or a separate task. This would consume too many resources for resource-constrained network devices.

Yet another prior art solution, described in Valdes, A., Skinner, K., “Adaptive, Model-based Monitoring for Cyber Attack Detection,” http://www.sdl.sri.com/papers/a/d/adaptbn/adaptbn.pdf, uses the Common Vulnerabilities and Exposures (CVE) list (http://www.cve.mitre.org/) to embed sensor code in source of the server code. Therefore, the server can detect intrusions listed in CVE if the corresponding sensor and detection code are in place. The main advantage of this approach is its effectiveness in real-time with minimal impact on system performance.

Many commercial security products, such as intrusion detection systems (IDS) are available to secure and protect networks against denial-of-service attacks. Internet firewalls, global defense infrastructures, are used to protect the Internet. These approaches protect embedded network devices in the way that they protect the network. However, the embedded network devices are still in danger if the devices are connected to the Internet via host computers. A host computer may launch, knowingly or unknowingly, DoS attacks against the devices connected thereto. For example, a maliciously installed malware or a computer worm on a host computer may launch such attacks. Because attack packets may not go to the outer network, defense mechanisms setup at the network level or at routers will not be able to help. The resource constrained network devices much have their own defense mechanisms that can live with the resource limitations of the devices.

From the foregoing it will be apparent that there is still a need for an improved system and method to detect network-based attacks against network-connected electronic devices. Such a system and method should be simple, use existing infrastructure, use only the resources and hardware intrinsically available to the electronic device, and without requiring building of data bases that catalog signatures of particular attacks or particular devices prone to attack.

### SUMMARY OF THE INVENTION

In a preferred embodiment, the invention provides a system and method for detecting network-based attacks on a network-connected electronic device. The system and method according to the invention uses analysis of the operation of the electronic device in processing incoming communications packets to determine whether the electronic device is under a network-based attack.

A system and method for operating an electronic device according to the invention to detect network-based attacks on the electronic device includes receiving data packets on the electronic device, tracking disposition of the data packets by the electronic device by recording one or more paths through a finite state machine model of the processing of data packets by the electronic device, and raising an alert that the electronic device is under a network-based attack based on patterns of the one or more recorded paths.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the operating environment in which a network-connected electronic device according to the invention may be deployed.

FIG. 2 is a schematic illustration of an exemplary architecture of the hardware of a network-connected electronic device that may be used in conjunction with the invention.

FIG. 3 is a high-level schematic illustration of one example of certain hardware and software elements, including a communications module, of a network-connected electronic device that is connected to a computer network.

FIGS. 4 through 6 are schematic drawings of an exemplary finite state machine corresponding to the communications module illustrated in FIG. 3, each showing different aspects of the processing flow through the finite state machine.

FIG. 7 is a more detailed view of the hardware and software elements of the network-connected electronic device shown in FIG. 3.

FIG. 8 is a flow-chart illustrating an example process used by one of the communications module sub module of the communications module of FIG. 3.

FIG. 9 is a flow-chart illustrating the process flow of the netserver node to process metrics from the other metrics-bearing states.

FIG. 10 is a timing diagram showing the relationship between an observation period for observing incoming TCP packets for the purpose of determining if the electronic device is under a TCP-flood attack.

FIG. 11 is a block diagram illustrating some of the software modules for implementing the network-based attack method of the invention and that may be stored, for example, in the NVM of a network-connected electronic device incorporating the functionality provided by the present invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

As shown in the drawings for purposes of illustration, the invention is embodied in a network enabled electronic device, e.g., a network smart card, equipped with the capability of detecting network-based attacks, particularly denial-of-service attacks, using a simple and elegant system and method that may be deployed on the electronic-device without the addition of external resources or databases. A network-based attack detector of such an network-connected electronic device provides a method, for example, implemented in software, that uses a finite state machine model for the processing of incoming packets to detect patterns in the paths through the finite state machine model that would be indicative of a network-based attack against the network-connected electronic device thereby providing a system and method for protecting the network-connected electronic device against such external attacks. As such, the system and method for detecting network-based attacks according to the invention uses the operational behavior of the electronic device as an indicator of whether the electronic device is under attack. The system and method for detecting network-based attacks according to the invention requires no additional hardware resources and very limited additional processing and memory resources and is therefore suitable for use in network-enabled resource-constrained devices, i.e., devices with limited memory, bandwidth, or processing power.

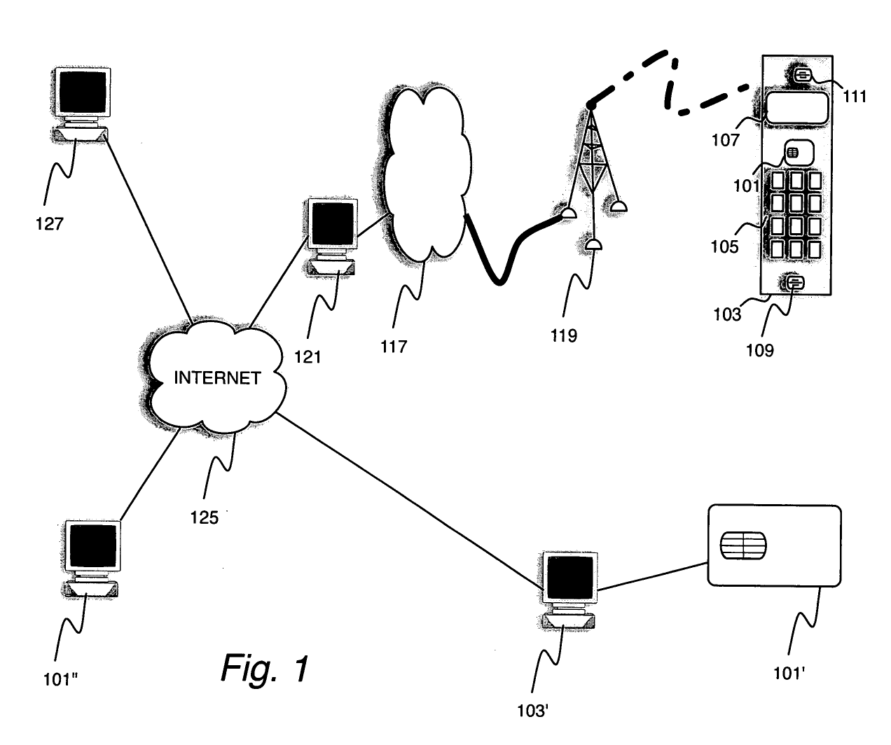

FIG. 1 is a schematic illustration of the operating environment in which a network-connected electronic device according to the invention may be deployed.

In one example, a network-enabled electronic device 101 is a network smart card installed into a handset 103. The handset 103 may be a mobile telephone having the usual accoutrements of a mobile telephone such as a keypad 105, a display 107, a microphone 109 and a speaker 111. In alternative embodiments, the handset 103 may be a personal digital assistant or any other mobile device using a SIM card. The handset 103 also contains an electronic circuitry (not shown) including a central processing unit and memory. Furthermore, there are a variety of smart mobile devices available, such as web-enabled phones, smart phones, PDAs, handheld PCs and tablet PCs. Many of the smart phones and PDAs combine the cell phone and PDA functionalities. Popular operating systems for smart mobile devices include Symbian, Palm OS, and Microsoft Smartphone. The invention described herein is applicable to such devices if they have SIM device that is a network smart card 101.

The electronic circuitry provides communications functionality for the handset 103 with a wireless network 117 via a wireless link to a wireless telephony antenna 119. And the microprocessor provides some of the control functionality of the handset 103, such as managing operations of the handset 103 and managing communications protocols used to communicate with the wireless network 117. The network smart card 101 is connected to the electronic circuitry so as to allow communication between the network smart card 101 and the handset 103.

The wireless network 117 is composed of a complex communications infrastructure for providing connections to other stations, for example, other mobile stations or land-based telephone systems. One such station may be an Internet gateway 121, which gives the wireless network 117 access to the Internet 125. As commonly known, very many computers are connected via the Internet. In the scenario presented herein, a user of a handset, e.g., a mobile telephone or a PDA, uses the infrastructure illustrated in FIG. 1 to communicate with the network smart card 101 either via the handset 103 or some other computer connected to the Internet 125. Some aspect of this communication uses direct communication between the network smart card 101 and the remote entity 127, for example, for the purpose of communicating some information that is stored on the network smart card 101 to the remote entity 127.

Another example, of a network-connected electronic-device 101′ is a network smart card having a credit card form factor and which is connected to the Internet 125 via a host computer 103′.

A network smart card 101 or 101′ is a smart card that is capable to act as an autonomous Internet node. Network smart cards are described in co-pending patent application Ser. No. 10/848,738 “SECURE NETWORKING USING A RESOURCE-CONSTRAINED DEVICE”, filed on May 19, 2004, the entire disclosure of which is incorporated herein by reference. A network smart card 101 implements Internet protocols (TCP/IP) and security protocols (SSL/TLS) built into the card and may implement other communications protocols as described herein below. The network smart card 101 can establish and maintain secure Internet connections with other Internet nodes. The network smart card 101 does not depend on a proxy on the host to enable Internet communications. More over, the network smart card 101 does not require local or remote Internet clients or servers to be modified in order to communicate with the smart card.

The invention is also applicable for use in other devices, including other network-enabled resource-constrained devices, and is not necessarily limited in use to resource-constrained devices. For example, a network-enabled electronic-device according to the invention may be a computer 101″. Herein, the term network-enabled electronic-device refers to any electronic device that is connected via a network to other electronic-devices and is capable of communicating electronically with such other devices. Similarly, the reference numeral 101 is used to refer to any such device and not specifically to any one such device.

In the scenario depicted in FIG. 1, an attacking computer 127 is a computer that acts as a source of DoS attacks against one of the network-connected electronic devices 101. The attacking computer 127, by itself or through reflectors, transmits numerous data packets to the target electronic device 101 with the intent to interfere with the use of some resource, e.g., another resource connected to the Internet, that the target electronic device 101 wishes to access. These communications packets are received and processed by the target electronic device 101.

The network-connected electronic device may be a network smart card, e.g., smart card 101′. Network smart cards, which are described in co-pending patent application Ser. No. 10/848,738 “SECURE NETWORKING USING A RESOURCE-CONSTRAINED DEVICE”, filed on May 19, 2004, the entire disclosure of which is incorporated herein by reference, combine the functionality of traditional smart cards with the capability of acting as autonomous network nodes by implementing a communications protocol stack used for network communication. In the event that the network-connected electronic device 101 connects to the network via a host computer 103′, the host computer 103′ may be the attacking computer, for example, as a reflector or by having some malware installed thereon.

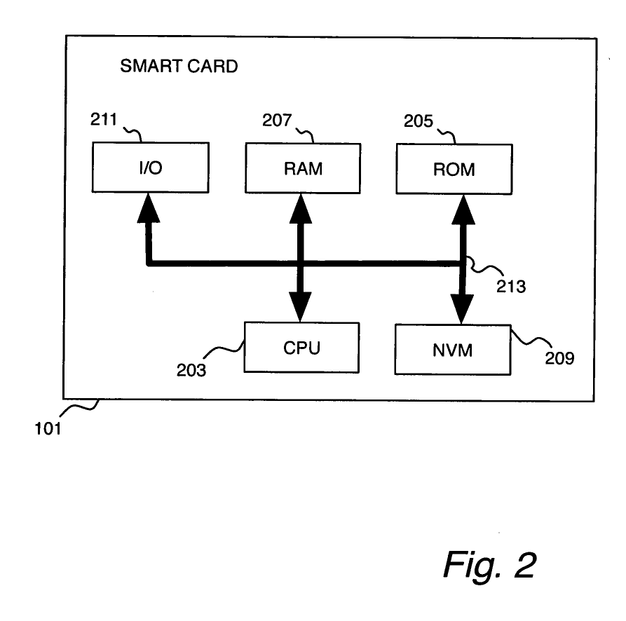

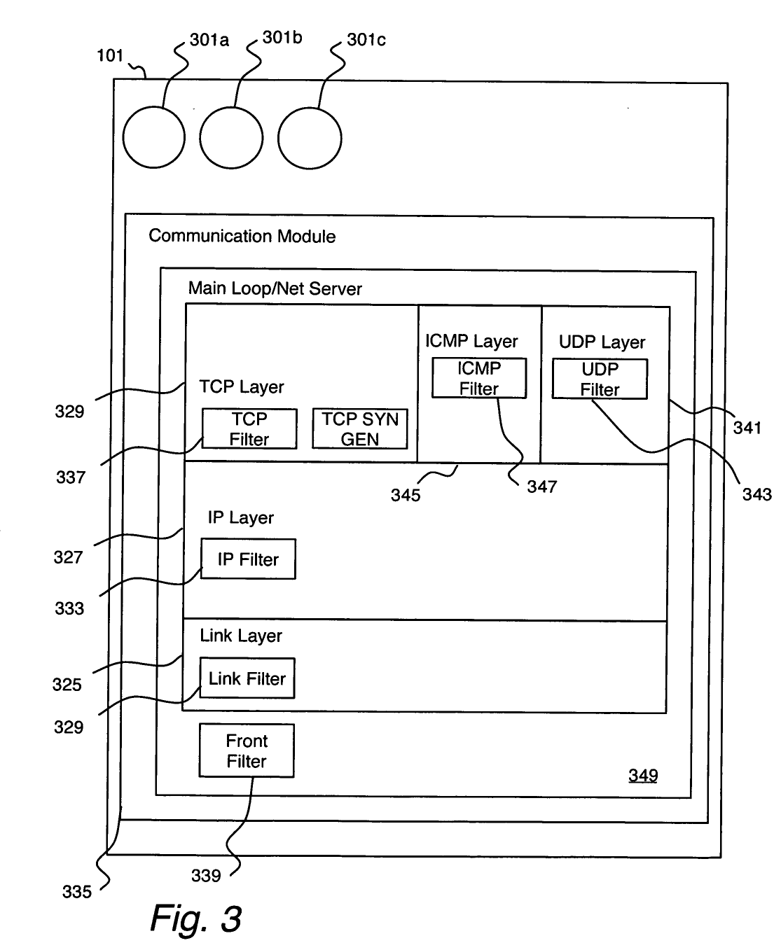

FIG. 2 is a schematic illustration of an exemplary architecture of the hardware of a network-connected electronic device 101 that may be used in conjunction with the invention. The network-connected electronic device 101, according to the example of FIG. 2, has a central processing unit 203, a read-only memory (ROM) 205, a random access memory (RAM) 207, a non-volatile memory (NVM) 209, and a communications interface 211 for receiving input and placing output to a computer network, e.g., the Internet, to which the network-connected electronic device 101 is connected, either directly or via intermediary devices, such as a host computer 103′. These various components are connected to one another, for example, by bus 213. In one embodiment of the invention, a communications module 335 (introduced in FIG. 3 below and described herein below in conjunction with FIG. 3 and other figures herein), as well as other software modules described herein below, would be stored on the resource-constrained device 101 in the ROM 205. In alternative embodiments, the software modules stored in ROM 205 would be stored in a flash memory or other types of non-volatile memory. For purposes of illustration, the invention is described using the ROM example. However, that should not be construed as a limitation on the scope of the invention and wherever ROM is used, flash memory and other types of non-volatile memory can be substituted as an alternative.

The ROM 205 would also contain some type of operating system, e.g., a Java Virtual Machine. Alternatively, the communications module 335 would be part of the operating system. During operation, the CPU 203 operates according to instructions in the various software modules stored in the ROM 205 or NVM 209.

Thus, according to the invention, the CPU 203 operates according to the instructions in the communications module 335 to perform the various operations of the communications module 335 described herein below.

FIG. 3 is a high-level schematic illustration of one example of certain hardware and software elements of a network-connected electronic device 101 that is connected to a computer network. The network-connected electronic device 101 has a communications module 335, for managing communication between the electronic device 101 and other devices connected to the network. The example of FIG. 3, illustrates just a few possible a communications protocol layers that the communications module 335 may implement. The network-connected electronic device 101 may, for example, communicate with a host device 103 over a USB link. This is not explicitly illustrated in FIG. 3. Many other alternative communication protocols may be implemented, e.g., direct physical contacts using ISO-7816, infrared link, Ethernet, MMC. Above the hardware layers and lower level protocols (not shown), the communications module 335 may have a link layer implementation 325 (referred to herein as a link layer module). The other layers in the protocol stack may include an IP layer implemented as IP module 327, a TCP layer implemented as TCP module 329 an ICMP layer implemented as ICMP module 345, and a UDP layer implemented as UDP module 341. The link layer may be PPP or Ethernet for establishing network connection.

The communication modules 335 provide communications services to one or several application programs 301a-c. The application programs 301 may, for example, be web server, or other network server, client or agent applications.

In the example of FIG. 3, the network layer is the Internet Protocol (IP). The Ethernet frames carry IP datagrams. in this embodiment, the transport layer is TCP or UDP. IP datagrams carry TCP or UDP messages. In further alternative embodiments, the IP datagrams carry messages in other communications protocols, e.g., ICMP, IGAP, IGMP, ROMP, GGP, IP in IP encapsulation, ST, UCL, CBT, EGP, IGRP, NVP, HMP (See e.g., IP, Internet Protocol, http://www.networksorcery.com/enp/protocol/ip.htm). Once all packets forming a message have arrived to the destination, they are recompiled into the message. In short, the TCP/IP network transmits messages via packets.

Throughout the communications stack, e.g., communications layers 325, 327, and 329, packet filtering is used to filter the packets to decide whether or not to pass the packets onto the next communications layer or to the application programs 301, or to drop the packets. For example, a Link layer filter 331 operates to filter packets at the link layer, an IP layer filter 333 operates to filter packets at the IP layer and a TCP layer filter 337 operates to filter packets at the TCP layer. For the purpose of processing UDP packets, the communications module 335 may include a UDP layer module 341 having a UDP packet filter 343. Similarly, for the purpose of processing ICMP packets, the communications module 335 may include an ICMP layer module 345 having a ICMP packet filter 347.

Additionally, a front-end filter 339 may be deployed to perform any packet filtering that may be done prior to processing by the communications stack.

Typically, the communications module 335 operates under the control of a main event loop 349 (herein referred to as the net server). A packet is processed by the communications module by being passed along from one of the communications module sub modules to another until the packet has been processed or consumed. A packet cannot be at more than one part of the communications module 335 at the same time. This presents a burden on resource-constrained network devices because these typically have only a single microprocessor. While most resource-constrained systems are single-task systems, there exist a few multi-task resource-constrained systems. However, because of the resource constraints and the cost of context switch, with a multi-task OS, the communications module 335 is typically in a single task. In such systems, one sub module of the communications module 335 executes at a time. Even if the network module is implemented in multiple tasks, for example, the link layer, IP layer and TCP layer have separate tasks, a single packet still goes through one layer at a time. It is therefore possible to model the communications module 335 as a finite state machine. This is not to be confused with the TCP state machine which dictates the connection progress of a TCP connection; rather the communications module 335 state machine is a model the entire communications module 335. Each state in the state machine represents a functional part of the network module. For example, a packet filter is represented by a state. A part of the TCP layer, for example, the logic responding to SYN, is represented by another state. For a multi-task network module, it is possible that several filters process the same packet in parallel. In such systems, these filters, as a whole, should be treated as a single state because a drop decision of one filter determines the fate of the packet.

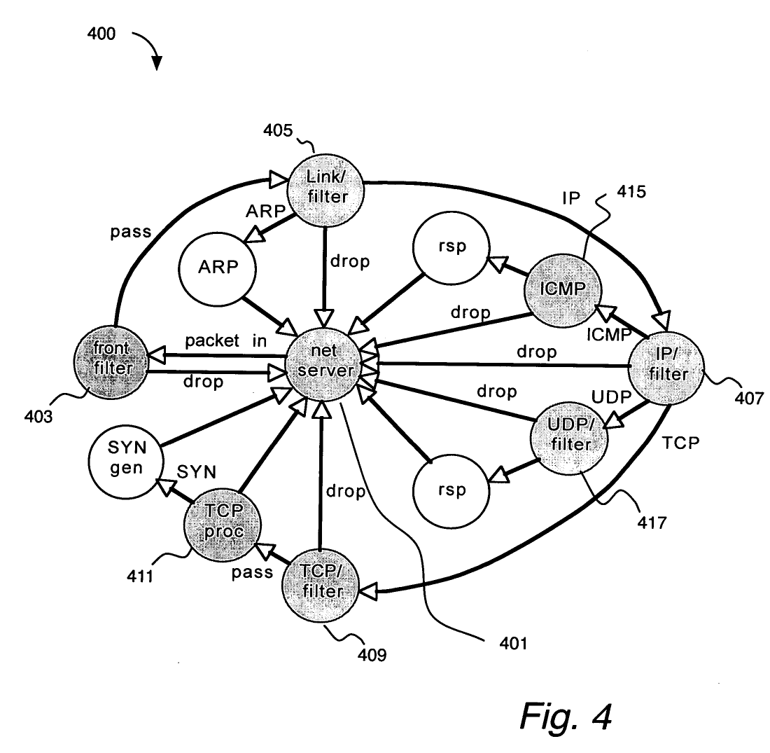

FIG. 4 is an exemplary finite state machine 400 corresponding to the communications module 335 of FIG. 3. It should be noted that the state machine 400 represents the state transitions of processing of a packet rather than a software implementation of the communications module 335.

The finite state machine 400 of the communications module 335 represents operational behaviors of the system. An electronic device according to the present invention deploys an operation-based detection method that detects DoS attacks, and possibly other attacks, based on the state machine model for the communications module 335. It must be realized that different communications modules may be modeled according to different finite state machines. Accordingly, the finite state machine 400 should only be considered an example; in this case particularly directed to the operation of the communications module 335, which is also only to be taken as an example.

The expected behaviors of the communications module 335, i.e., a normal path of transitions for the correct processing of a useful communications packet, are referred to as positive paths of state transitions. On the other hand, negative paths of state transitions refer to the behaviors of the communications module 335 when handling abnormal traffic. In certain situations, a positive path may become a negative path.

According to the method of the present invention, metrics are defined for each negative path according to heuristics and experiences. When one or more of the metrics exceed their respective thresholds, the communications module 335 raises an alarm for a possible network-based attack. The thresholds may be dynamically updated according the packet traffic situation.

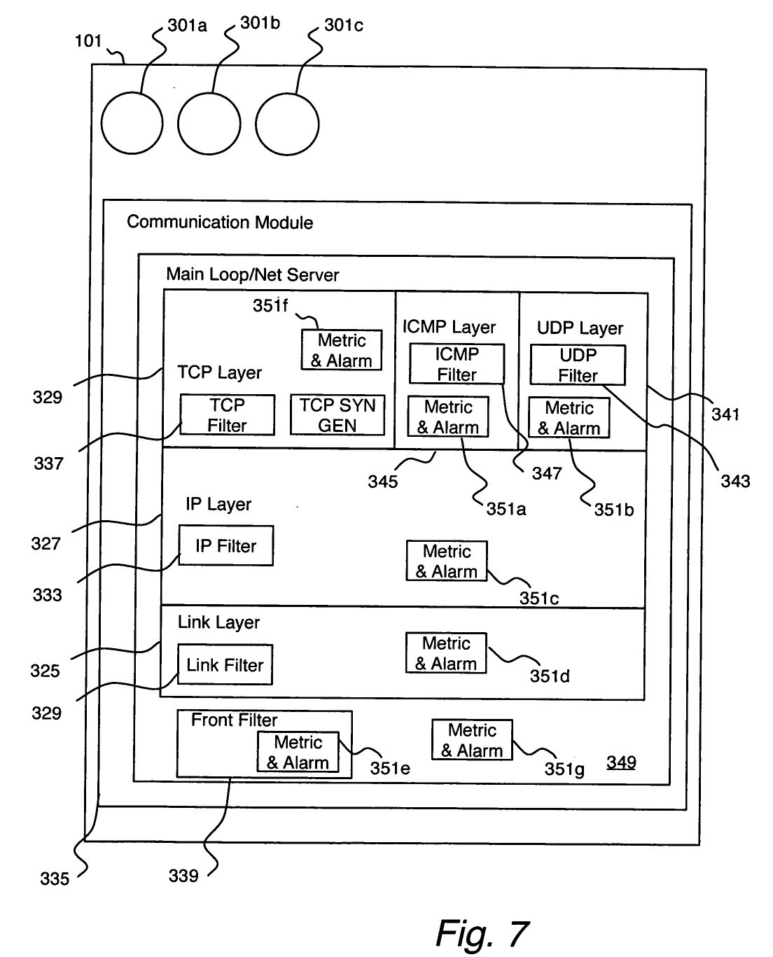

Herein, we use an example to illustrate the system and method for detecting network-based attacks according to the invention by means of an example illustrated in the figures, e.g., the state machine of FIGS. 4 through 6 and the communications module of FIGS. 3 and 7. These examples are by no means to limit the topology and transitions of the state machine, the particular communications module, nor to the particular metric described herein.

In the example of FIG. 4, the main loop (or net server) is represented by the inner node 401, which is both the start state and stop state for the processing of a packet. The communications module 335 is event driven by the input from the network output to the network, requests from the applications 301, and timer events.

When the net server 349 receives the packet-in event, the netserver 349 invokes the front-end packet filter 339 (a front-end packet filter is described in Lu, H. K, “Multi-Stage Packet Filtering for Resource Constrained Embedded Network Devices,” U.S. patent application Ser. No. 11/246,736, filed Oct. 8, 2005, the entire disclosure of which is incorporated herein by reference), state 403. The front-end packet filter 339 may either pass or drop the packet. If the packet is dropped, control is returned to the net server 349, state 401. The path of state transitions, from the net server (state 401) to the front-end filter (state 403), then back to the net server (state 401), forms a loop. The transitions of the state machine form many loops, which leave the net server (state 401) and eventually return to the net server (state 403). Every packet goes through one loop or another, being consumed (used) or being dropped.

The system expects to receive good packets, use these packets, and send out packets when needed. The finite state machine 400 of the communications module 335 models the expected system behaviors through positive paths of state transitions that lead to consumptions of packets, as opposed to dropping packets. In this example, the positive paths of transitions form positive loops.

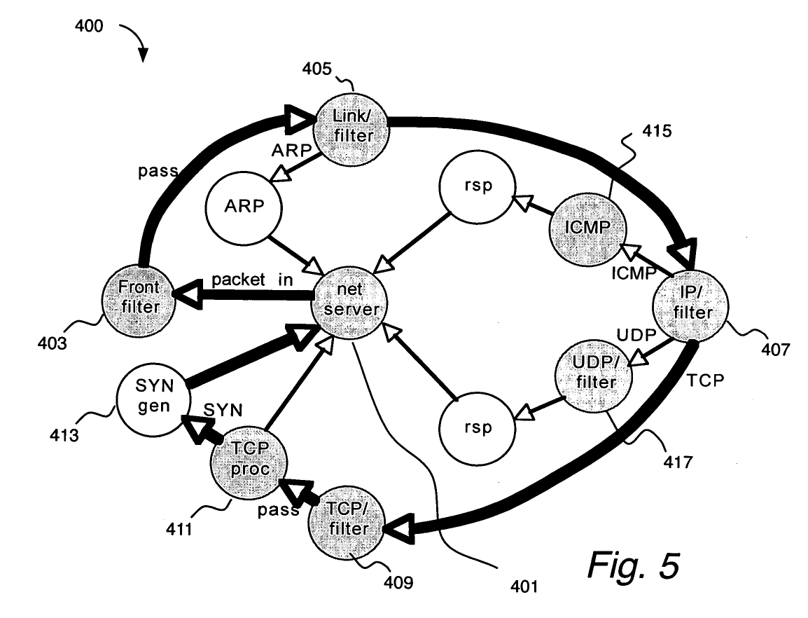

FIG. 5 is a schematic illustration of the finite state machine 400, which illustrates the paths of all the positive loops of the state machine 400. The loop (401-403-405-407-409-411-413-401) formed by heavy black arrows is one example of a positive loop, where the packet is a TCP SYN packet.

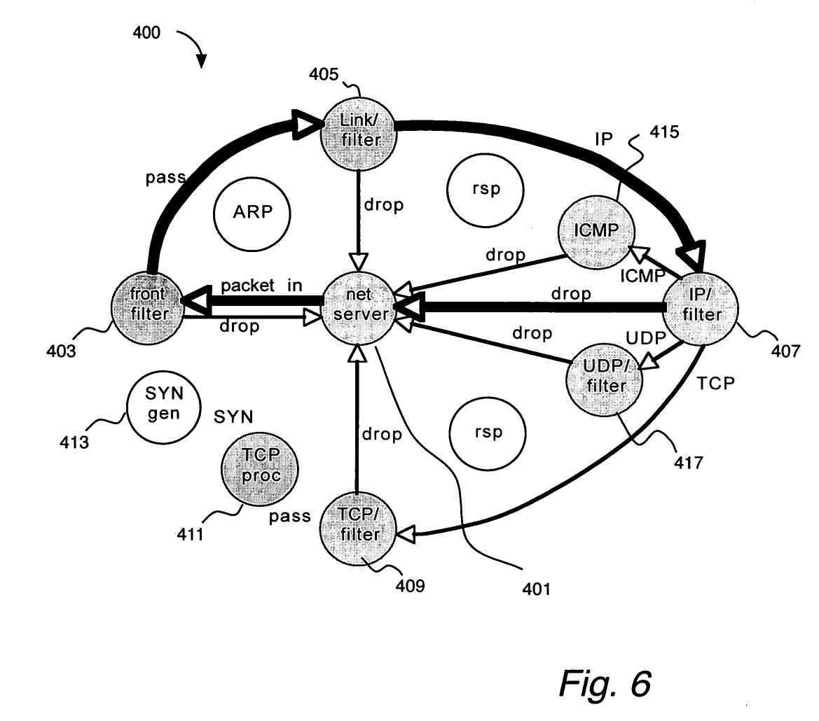

The paths through the state machine 400 traversed by dropped packets are negative paths of state transitions. These paths represent the operational behaviors of the network module in handling unexpected or abnormal network traffic. In the example of FIG. 4, the negative paths of transitions form negative loops. FIG. 6 is a schematic illustration of all the negative loops through the state machine 400. The loop (401-403-405-407-401) formed by heavy black arrows is one example of a negative loop, where a packet filter 333 at the IP layer 327 drops a packet.

Continuous repetitions of negative loops indicate that the communications module 335 is continuously handling abnormal network traffic. The detection system of the communications module 335 should raise an alarm. In certain situations, a positive loop may become a negative loop. For example, in FIG. 5, the loop (401-403-405-407-409-411-413-401) of dark black arrows representing TCP SYN packet path becomes a negative loop when the system is under SYN flooding attack. Such situation can be detected by sensing unexpected continued repetitions of particular positive loops. Therefore the detection system according to the invention detects flooding based DoS attacks by observing behaviors of the network module through unexpected repetitions of state transition loops.

To provide the functionality implementing the attack-detection method of the present invention, each module that provides packet processing implements one or more metrics associated with the dropping of packets or unexpected repetitions of state transition loops. For example, illustrated in FIG. 7, which is a further schematic illustration of the communications module 335 of FIG. 3, each of the communications protocol layers 325, 327, 329, 341, and 345 as well as the main loop or net server 349 and the front-end filter 339 may implement a metric and alarm module (351a-g, respectively). The metric and alarm modules 351a-g, respectively, are used by the communications module to compute metrics associated with the various nodes in the finite state machine 400.

To quantify unexpected repetitions of state transition loops, metrics are defined for some of the states in the state machine 400. In FIGS. 4, 5, and 6, grey nodes 401, 403, 405, 407, 409, 411, 415, and 417 represent states with metrics defined. Most of these states are associated with packet filters, e.g., the front-end filter 339, the link layer filter 329, the IP layer filter 333, the UDP filter 343, the ICMP filter 347, the TCP filter 337, which make drop or pass decisions. The states also represent processing performed by their respective communications protocol layer implementations. Metrics may also be associated with certain processing nodes, e.g., the TCP processing state 411 corresponds to the processing of a TCP SYN request and the ICMP state 415 corresponds to the processing of ICMP packets. Furthermore, the netserver 349 also may compute metrics, for example, metrics that depend on metrics values obtained from the other states. The metrics may be different from state to state; a few examples are described herein below. Each metrics-bearing state computes or accumulates its own metrics. When a metric of a state exceeds certain pre-defined threshold, the state raises an alarm. Therefore, these states, grey nodes, are sensors for the attack detection system.

The net server state 401 is one of the metrics-bearing states. In addition to accumulating its own metrics, the net server/main loop 349 may monitor the alarm activities of other states. If any alarm rings, the net server informs the operating system of a possible network-based attack.

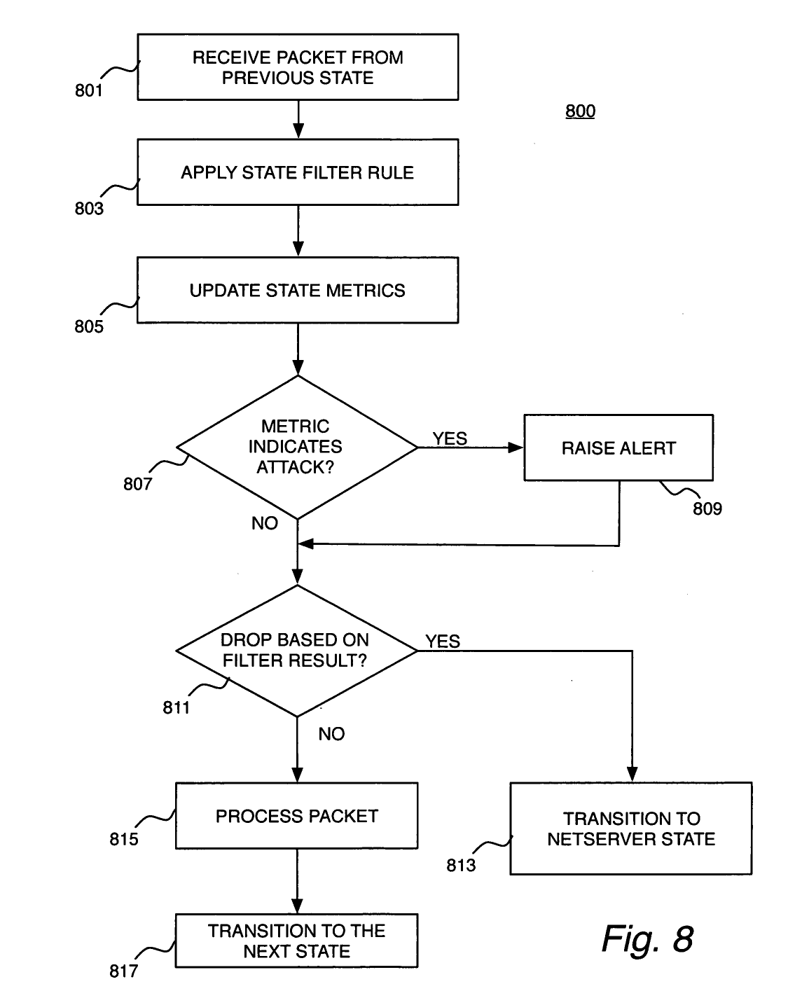

FIG. 8 is a flow-chart 800 illustrating an example process by one of the communications module 335 sub modules, e.g., the front-end filter 339, the TCP layer 329, the IP Layer 327, the Link Layer 325, the ICMP Layer 345, or the UDP Layer 341. This process 800 may be implemented as a part of the implementation of the respective layer and may include the metrics and alarm modules of any one such layer, e.g., the metrics and alarm modules 351a-g.

First, the layer or module would receive the packet from the previous state, step 801. Next, the layer would apply its filtering rule, step 803. Next, the layer updates its state metrics, step 805. There may be multiple metrics associated with any one layer and state.

If any of the metrics of the state indicates that the communications module 335 is under attack, decision step 807, the metric and alarm module 351 raises an alarm, step 809. If a state contains multiple metrics, an alarm may be raised based on a combination of those multiple metrics. In case of the metric and alarm modules 351 associated with the states other than the netserver state 401, i.e., the metric and alarm modules 351a-f, raising the alarm may be a return code passed back to the main loop 335 when control is passed back. Alternatively, the alarms can be made to cause interrupts and having an interrupt handler handle the alarm situation.

If the filter indicates that the packet should be dropped, decision step 811, control is passed back to the main loop 349, step 813. On the other hand, if the filter result indicates that the packet is acceptable, the communications layer processes the packet, step 815, and then passes the packet on to the next layer, e.g., according to the state machine 400, step 817.

As examples, some simple metrics are defined herein. More complex metrics, such as high order or statistical metrics as proposed in the literature, e.g., Siaterlis, C. and Maglaris, B., “Towards Multisensor Data Fusion for DoS Detection,” The 19^{th} Annual ACM Symposium on Applied Computing, March 2004, may be adopted if appropriate for particular network-connected electronic devices 101, e.g., for resource-constrained network-connected electronic devices. The operation-based attack detection method of the present invention does not mandate any particular metric or set of metrics. In an alternative embodiment, the metrics for detecting attacks may be defined using likelihood instead of clear-cut thresholds, i.e., by returning a likelihood of attack value to the main loop 335.

Consider an implementation in which there is multiple metrics associated with each metrics-bearing state. Let Nᵢⱼ be the j^{th} metric computed for the I^{th} state; φᵢⱼ be the corresponding threshold, i.e., the value of the state metric which would indicated that according to the metric the communications module 335 is under a network-based attack; and Pᵢⱼ be the likelihood of an attack that the state believes. Then:
if (Nᵢⱼ>=φᵢⱼ)
{Pᵢⱼ=1} else
{Pᵢⱼ=Nᵢⱼ/φᵢⱼ} (1)

The value of Pᵢⱼ is in the range [0, 1], where 1 means that the state believes there is a network-based attack and 0 means no attack. The total likelihood from state i can be defined as:
Pᵢ=Σᵢⱼ(αᵢⱼ×Pᵢⱼ) (2)
where the αᵢⱼ's are parameters with:
Σij αᵢⱼ=1 for a given i and αᵢⱼ≧0. (3)
The overall attack likelihood detected from the state machine can be defined as:
P=Σᵢ(βᵢ×Pᵢ) (4)

where the βᵢ's are parameters with
Σᵢβᵢ=1 and βᵢ≧0.

Thus, Pᵢ is a weighted average of the metrics for state i and P is a weighted average of the weighted averages from the various states i.

The parameters αᵢⱼ's and βᵢ's may be predefined according to experience and experiments. The parameters may also be adjusted dynamically. In the above equations, the value range of the attack likelihood metric P is [0,1] with 1 as positive attack detection and 0 as no attack detected. As noted above, the netserver state 401 may have its own metric or combine the results from the metrics of the other states. The value P, from equation 4, is an example of a combination of the metrics results from the various states and may be performed by the netserver main loop 335.

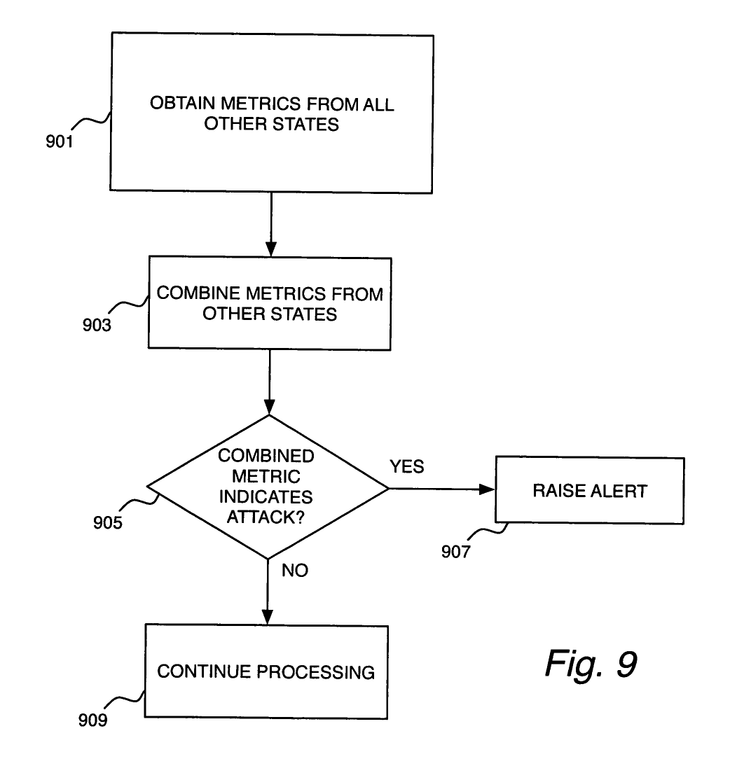

FIG. 9 is a flow-chart illustrating the process flow of the processing of metrics from the other metrics-bearing states, for example, by the netserver metrics and alarm module 351g. First all the metrics from the other states are obtained, step 901. The metrics are then combined according to some formula, e.g., equation 4. If the combined metric indicates that an attack is likely, decision step 905, an alarm is raised, step 907. Otherwise, processing is continued, step 909.

In an alternative embodiment, the alerts from various states may include a reason for an alert. This enables the system to better respond to the potential threat. Once a network-based attack is detected, the network device should protect its data and files, warn the user, and try to continue if needed and possible.

This network-based attack detection method can detect various network-based attacks, including the DoS attacks, because several states relate to the packet filtering. Properly designed packet filtering can drop malicious packets and useless packets, which provides information about potential network-based attacks. With the multi-stage packet filtering (described in co-pending patent application Ser. No. 11/246,736) the unwanted packets are filtered out as early as possible. Therefore, the potential attacks will be detected as early as possible.

Typically the communications module 335 is implemented as a main event loop. The following (Table 1) is an example code (written in a C language syntax) for a main event loop for the netserver of the communications module 335:

TABLE 1
Sample Code for main event loop 335.

While (1)
{

event = waitEvent( );
switch (event)
{

case Timer:

processTimeout( );
break;

case PacketIn:

processNewPacket( );
break;

... ...

}

}

An event in the main control loop might be a timer event, an I/O event, or an application request (for example, a socket event). Each metrics-bearing state (e.g., states 401, 403, 405, 407, 409, 411, 415, and 417) accumulates metrics for the events that are monitored by that state. For example, if a SYN request, the TCP processing state 411 may increase a count indicative of the receipt of a SYN request. When a metric exceeds a threshold associated with the metric, an alert is set either by setting a flag or alerting the operating system. The metrics may be reset to initial values at certain timer events.

Consider the TCP SYN monitoring as an example, i.e., an embodiment of the invention in which TCP SYN attacks are being guarded against. The Transmission Control Protocol uses a retransmission timer to cause the retransmission of data that has not been acknowledged by the receiver. The retransmission timer may be used by the TCP processing state as a basis for a timer event. If the timer expires every 500 ms, set the observation period, τ, to be some multiple, Const, of the timer period. If the observation period τ is to be three times the timer period, Const is equal to 3, which is herein below a the value of Const for illustrative purposes. Let N be the number of SYN packets received and φ be a threshold. When a TCP SYN packet arrives, the TCP processing state 411 increments the counter N by 1. If N exceeds during the observation period, the state raises an alarm. This is illustrated by the code in Table 2 below:

TABLE 2
Example program code for processing of a SYN Packet

If (SYN packet) {

N = N + 1;
if (N >= φ) {

raise alarm;
// reset
t = 0;
N = 0;

}

}

When the net server receives a timer event, all states increment their respective t values by 1, i.e., t=1. For the TCP SYN monitoring example, when t=3, that is, the observation period, τ, has been completed, if N>=φ, the state raises an alert. Also, when the observation period, τ, has been completed, both N and t are reset. This example is illustrated in the sample code of Table 3 below:

TABLE 3
Sample code illustrating the raising of an alarm when
a metrics threshold has been reached or exceeded.

If (timer event)

t = t + 1;
t == Const) {

if (N >= φ) {raise alarm}
// reset
t = 0;
N = 0;

}

}

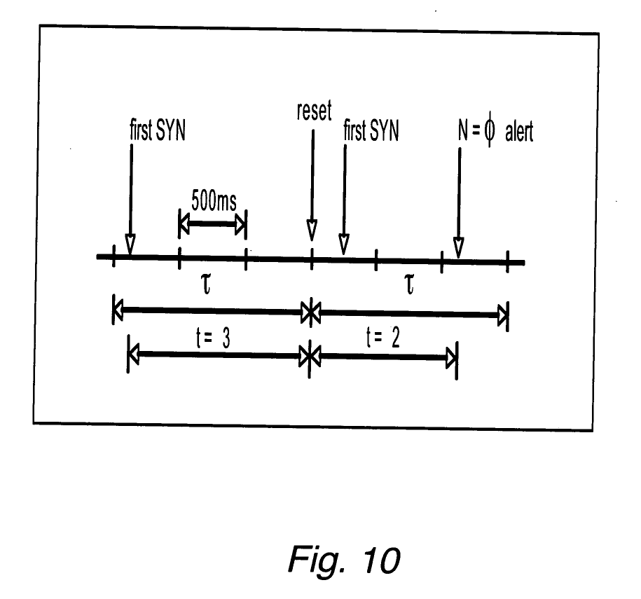

Practically, since the arrival of a TCP SYN packet may not be precisely on a timer tick, the actual accumulation time is normally less then τ. This is illustrated in FIG. 10.

Example metrics for the netserver state 401 use the number of dropped packets (N_{d}) over a time period (T) to decide whether to raise an alarm. Each of the states, for example, the front-end filter 403, that is capable of dropping packets according filtering rules may use a bit flag to indicate if an incoming packet is passed through this state or is dropped. As explained earlier, all transition loops start and end at the net server state 401. The net server state 401 can check the bit flag to determine if a packet was useful or was dropped. Two metrics may be defined for the net server state 401 as the following:
1. Let N_{d} be the number of dropped packets during time T. The net server will raise an alarm if the following are true:
   N_{d}≧φ and T≦τ
Where φ is a threshold; τ is the observation period. Both values that can be set according to the typical operational environment, such as bandwidth, and typical applications that the network-connected electronic device 101 provides. The φ and τ values may be dynamically adjustable, e.g., if a user determines that the communications module 335 raises alerts too frequently.
2. Let Nₚ be the number of useful packets (passed all the filters) and N_{d} the number of dropped packets during time T. The net server 401 will raise an alarm if the following is true where δ>>1:
   N_{d}/Nₚ>δ and T≦τ

Both metrics above involve dropped packets, which corresponds to the negative state transition loops in the state machine 400 illustrated in FIG. 6. When the operation of the communications module 335 focuses on dropping packets, that is an indication that the network-connected electronic device 101 is under a flooding-based DoS attack. The metrics represent dropping intensities, where the first one is an absolute measure and the second is a relative measure. These metrics at the net server node 401 can detect unknown flooding-based DoS attacks because the metrics are neutral with respect to packet types.

Other states that are capable of dropping packets according filtering rules may use similar metrics as the net server 401. However, the thresholds associated with those states may be different from those of the net server 401. Furthermore, the thresholds may be different from state to state. These states can detect known or unknown attacks because the types of packets that enter into the states are narrowed. For example, the ICMP state 415 can detect ICMP echo request flooding attack. The attack information may be fed back to the front-end packet filter 339, which blocks out particular packets at the front door of the communications module 335. For example, a variable “attack type” may be forwarded to the front-end packet filter 339 to indicate the type of the attack. For example, the “attack type”=ICMP would indicate that the ICMP processing node 415 has detected an ICMP flooding attack. The front-end filter 339, which may or may not be implemented as an Interrupt Service Routine filter, checks the attack type. If the “attack type” is ICMP, the front-end filter 339 would then drop all ICMP packets. (Usually, by default, ICMP packets are allowed to pass front-end filters).

The “TCP process” state 411 is more complex than other states. The TCP process state 411 monitors the TCP operations to detect abnormal behaviors. If the repetition of an abnormal behavior exceeds a given threshold, the TCP process state 411 raises an alarm. For example, when a TCP SYN packet comes to the TCP process state 411, it passes the packet to the SYN generation state 413, which then transfers control back to the net server state 401. This is normally a positive transition loop as illustrated in FIG. 5. However, if this loop repeats continuously and intensely, the loop becomes negative and the “TCP process” state 411 raises an attack alarm. For example, as a simple measure, the “TCP process” state 411 can monitor the distribution of packets based on packet types. If in a small observation interval T, the number of SYN packets is much greater than other packets, the network-connected electronic device 101 is probably under a SYN flooding attack and alarm is raised. The following define two example metrics used by the TCP processing state 411, which are similar to those for net server state 401.
1. Let Nₛ be the number of TCP SYN packets during time T. The net server will raise an alarm if the following are true:
   Nₛ≧φₛ and T≦τ
Where φₛ is a threshold; τ is the observation period. Both values that can be set according to the typical operational environment, such as bandwidth, and typical applications that the resource-constrained network device provides. The parameters φₛ and τ may be dynamically adjustable.
2. Let Nₛ be the number of TCP SYN packets and Nₒ the number of other packets during time T. The net server will raise an alarm if the following is true where δₛ>>1:
   Nₛ/Nₒ>δₛ and T≦τ.

The alert to the operating system of the network-enabled electronic device may be centralized or distributed. For a centralized alert, the net server state 401 listens to the alarms from other metrics-bearing states. Together with its own observation, the net server state 401 decides when to raise an alarm to the operating system. In one embodiment of the invention, each state uses a bit flag to represent an alarm. In the example of FIG. 6 one byte can represent the alarm situations of individual states. The net server 401 checks the alarm byte. If one of the bits is raised, the net server state 401 raises an alarm.

Alternatively, the alerts may be distributed directly from various states. Depending on the implementation, the centralized alert may be simpler and the code being more modular. In addition, some information fusion technique may be used for the centralized alert.

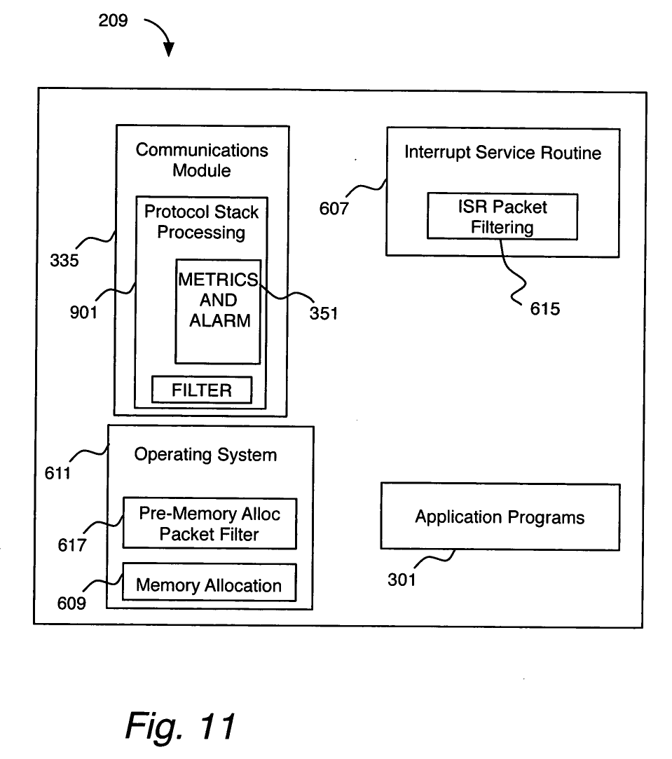

The method for detecting network-based attacks of the present invention as described herein may be implemented as a software program or a collection of software programs having instructions for controlling the central processor unit 203 of the network-connected electronic device 101. These software programs would normally be stored in the NVM 209 and loaded as needed for execution into the RAM 207. FIG. 11 is a block diagram illustrating some of the software modules that may be used for implementing the method for detecting network-based attacks of the invention and that may be stored, for example, in the NVM 209.

When an incoming data packet has been received over the I/O interface 211, this event would trigger an interrupt handled by an interrupt service routine 607. In addition to the instruction necessary to cause the CPU 203 to do some initial processing of the incoming data packet, the ISR 607 may also contain instructions to perform the functions of ISR packet filtering stage 615. The ISR packet filtering stage may be deemed one embodiment or aspect of the front-end filter 339.

The operations of the network-enabled device 101 is controlled by an operating system 611. The operating system 611 provides instructions to the CPU 203. One functionality provided by the operating system 611 instructions may include memory allocation 609 for incoming data packets. The operating system 611 may also contain instructions to cause the CPU 203 to perform the pre-memory allocation packet filtering stage 617, which may be deemed to constitute an alternative embodiment of the front-end filter 339.

The software programs stored in the NVM 209 also include the communications module 335 which implements a communications protocol stack processing module 901. The communications protocol stack would, in one embodiment, include instructions to cause the CPU to process the various protocol layers 325, 327, 329, 341, and 345. As noted herein above, other protocols may also be implemented or in lieu of these protocols. The protocol stack processing also includes the processing of the protocol stack packet filtering and the Metrics and alarm modules 351. In other words, the protocol stack processing module 901 contains instructions to cause the CPU 203 to perform the network-based attack detection method that is based on the operations of the communications module 335 as described herein above.

Finally, the NVM 209 may include some application programs 301, which are the ultimate consumers of the incoming data packets.

The method and system for detecting network-based attacks on a network-connected electronic device according to the invention uses the operations of a communications module by using a finite state machine to model the processing and filtering of incoming data packets through the various communications protocol layers. Herein, whenever the description indicates that a state or a node of a finite state machine performs a task, that should be taken to mean, for example, that a software of hardware module, e.g., one of the sub modules-implementation of communications protocol layer, actually performs the operation. An electronic device incorporating logic implementing or operating according to the method of the invention does not require any additional external resources or databases for storing signatures or other indicia of packets sent in a DoS attack. The system and method for detecting network-based attacks of the invention is a general framework for efficient detection of attacks and is therefore suitable for use on small resource constrained network devices and may also be deployed on larger systems. The system and method of detecting network-based attacks of the present invention has several advantages over existing attack detection systems, including reduced memory usage, and enhanced performance.

Although specific embodiments of the invention have been described and illustrated, the invention is not to be limited to the specific forms or arrangements of parts so described and illustrated. The invention is limited only by the claims.

What is claimed is the following:

1. A method for operating an electronic device, the method operable to detect network-based attacks on the electronic device, comprising:
receiving data packets on the electronic device;
tracking disposition of the data packets by the electronic device by recording one or more paths through a finite state machine model of the processing of data packets by the electronic device; and
raising an alert that the electronic device is under a network-based attack based on patterns of the one or more recorded paths.

2. The method of operating an electronic device of claim 1, further comprising:
characterizing loops having a path through the finite state machine as a negative loop if the path involves a received packet being dropped; and
wherein the step of raising an alert comprises raising an alert in response to substantially continuous repetition of negative loops.

3. The method of operating an electronic device of claim 1, comprising:
characterizing a loop as a negative loop, a loop that is a repetitive loop that includes a state of unfinished SYN three-way handshake.

4. The method of operating an electronic device of claim 1, wherein:
the step of tracking disposition comprises:
computing at least one metric for at least one node in the finite state machine; and
the step of raising an alert comprises:
raising an alert in response to a value of the at least one metric for at least one node.

5. The method of operating an electronic device of claim 4, wherein the step of raising an alert in response to a value of the at least one metric for at least one node comprises:
determining whether the metric exceeds a predetermined threshold value.

6. The method of operating an electronic device of claim 4, wherein the step of computing at least one metric for at least one node is selected from the set that includes the number of packets dropped by the at least one node during a given time period, a ratio between useful packets and dropped packets in a given time period, number of TCP SYN packets during a given time period, a ratio between TCP SYN packets and other packets during a given time period.

7. The method of operating an electronic device of claim 6, wherein the at least one metric is selected from the set including number of TCP SYN packets during a given time period, a ratio between TCP SYN packets and other packets during a given time period, wherein the given time period is a function of a TCP retransmission timer.

8. The method of operating an electronic device of claim 4, wherein the at least one node is a central node in the finite state machine and the step of computing at least one metric for at least one node comprises computing a metric for the central node and wherein the metric for the central node is a function of at least one metric of at least one other node.

9. The method of operating an electronic device of claim 8 wherein the metric for the central node is a weighted average of the at least one metric of the at least one other node.

10. The method of operating an electronic device of claim 9 wherein weighing factors for the weighted average are determined experimentally.

11. The method of operating an electronic device of claim 1, wherein the step of raising an alert based on patterns of the one or more recoded paths further comprises:
recording metric values at one or more states in the finite state machine.

12. The method of operating an electronic device of claim 10, further comprising:
in response to detecting that the electronic-device is under attack:
recording information characteristic of packets causing the attack; and
forwarding the recorded information to a front-end packet filter, thereby enabling the front-end packet filter to use the information to drop subsequent packets having same or similar characteristic to the information characteristic of the packets causing the attack.

13. An electronic device, having mechanisms thereon operable to detect network-based attacks on the electronic device, comprising logic for:
receiving data packets on the electronic device;
tracking disposition of the data packets by the electronic device by recording one or more paths through a finite state machine model of the processing of data packets by the electronic device; and
raising an alert that the electronic device is under a network-based attack based on patterns of the one or more recorded paths.

14. The electronic device of claim 13, further comprising logic for:
characterizing loops having a path through the finite state machine as a negative loop if the path is involves a received packet being dropped; and
wherein the step of raising an alert comprises raising an alert in response to substantially continuous repetition of negative loops.

15. The electronic device of claim 13, comprising logic for:
characterizing a loop as a negative loop, a loop that is a repetitive loop that includes a state of unfinished SYN three-way handshake.

16. The electronic device of claim 13, wherein:
the tracking disposition logic comprises logic for:
computing at least one metric for at least one node in the finite state machine; and
the step of raising an alert comprises:
raising an alert in response to a value of the at least one metric for at least one node.

17. The electronic device of claim 16, wherein the logic for raising an alert in response to a value of the at least one metric for at least one node comprises logic for:
determining whether the metric exceeds a predetermined threshold value.

18. The electronic device of claim 16, wherein the logic for computing at least one metric for at least one node is selected from the set that includes the number of packets dropped by the at least one node during a given time period, a ratio between useful packets and dropped packets in a given time period, number of TCP SYN packets during a given time period, a ratio between TCP SYN packets and other packets during a given time period.

19. The electronic device of claim 18, wherein the at least one metric is selected from the set including number of TCP SYN packets during a given time period, a ratio between TCP SYN packets and other packets during a given time period, wherein the given time period is a function of a TCP retransmission timer.

20. The electronic device of claim 16, wherein the at least one node is a central node in the finite state machine and the step of computing at least one metric for at least one node comprises computing a metric for the central node and wherein the metric for the central node is a function of at least one metric of at least one other node.

21. The electronic device of claim 20 wherein the metric for the central node is a weighted average of the at least one metric of the at least one other node.

22. The electronic device of claim 21 wherein weighing factors for the weighted average are determined experimentally.

23. The electronic device of claim 13, wherein the logic for raising an alert based on patterns of the one or more recoded paths further comprises:
recording metric values at one or more states in the finite state machine.

24. The electronic device of claim 10, further comprising logic for:
in response to detecting that the electronic-device is under attack:
recording information characteristic of packets causing the attack; and
forwarding the recorded information to a front-end packet filter, thereby enabling the front-end packet filter to use the information to drop subsequent packets having same or similar information to the information characteristic of the packets causing the attack.
